(19) United States
(12) Patent Application Publication
(10) Pub. No.: US 2005/0233758 A1
(43) Pub. Date: Oct. 20, 2005

(54) Method and apparatus to transfer recipient MMS capabilities to MMS originator

(75) Inventor: Matti Salmi, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/109,222

(22) Filed: Apr. 18, 2005

Related U.S. Application Data
(60) Provisional application No. 60/563,160, filed on Apr. 16, 2004.

(51) Int. Cl. H04Q 7/20

(52) U.S. Cl. 455/466

(57) ABSTRACT

Disclosed herein is a method, an apparatus and a computer program to operate a Multimedia Messaging System (MMS), comprising sending a MMS message from a sending mobile station to a recipient mobile station; selectively generating a delivery report that comprises MMS capability information of the recipient mobile station and, if generated, sending the delivery report to the sending mobile station.

### CLAIM OF PRIORITY FROM COPENDING PROVISIONAL PATENT APPLICATION

This patent application claims priority under 35 U.S.C. §119(e) from Provisional Patent Application No.: 60/563,160, filed Apr. 16, 2004, the disclosure of which is incorporated by reference herein in its entirety.

### TECHNICAL FIELD

This invention relates generally to message formats and procedures, and, more specifically, relates to Multimedia Messaging Service message formats and procedures used in wireless communication systems having wireless communication terminals, also referred to, by example, as mobile stations, user equipment, mobile phones, radiotelephones, cellular telephones and personal communicators.

### BACKGROUND

The following abbreviations are found in this patent application:

| | |
|---|---|
| 3GPP | 3rd Generation Partnership Project |
| MM | Multimedia Message |
| MMS | Multimedia Messaging Service |
| MMSE | a collection of MMS-specific network elements under control of |
| | a single administrator |
| OMA | Open Mobile Alliance |
| SIP | Session Initiation Protocol |
| SMIL | Synchronized Multimedia Integration Language |
| SMS | Short Message Service |
| TS | Technical Specification |
| UAProf | User Agent Profile |
| W3C | WWW Consortium |

The MMS has been specified for transporting content to a user from a content provider or an application. Reference can be had to 3GPP TS 23.140, V6.5.0 (2004-03), 3^{rd} Generation Partnership Project; Technical Specification Group Terminals; Multimedia Messaging Service (MMS); Functional Description; Stage 2 (Release 6), subsequently referred to herein simply as 3GPP TS 23.140. FIGS. 1, 2 and 3, based on FIGS. 3, 4 and 5, respectively, of 3GPP TS 23.140, are provided to show the MMS reference architecture, the protocol framework to provide MMS, and the interworking of different MMSEs, respectively. The document 3GPP TS 23.140 is incorporated by reference herein.

The MMS enables rich multimedia communication between mobile users. However, the multimedia capabilities of mobile stations vary significantly depending on the display size, audio capability and processing power. This creates an interoperability problem, since the sender, who pays for the multimedia message, does not necessarily know the capabilities of the recipient mobile station.

Recently, the problem has been addressed in the Open Mobile Alliance by introducing a message class concept, where a mobile station declares conformance to one or more message classes, for instance, Image rich or Video basic, and each class defines strict mandatory content rules. Content adaptation mechanisms are provided to fill the gaps between the classes.

The introduction of the message classes and related content adaptation significantly simplifies the problem, since the user has to have only elementary, simplified knowledge of the recipient capabilities. For example, the user need only know if the recipient has a video-capable or imaging-capable mobile station.

While the use of the message classes significantly simplifies the problem of the requirement to have knowledge of the recipient mobile station capabilities, it does not fully solve the problem. Moreover, the message classes tend to limit innovation, since any attempt to advance beyond the supported message classes introduces an interoperability problem.

The introduction of the interoperable message classes was at least partly in response to the desire by network operators to solve the imminent MMS interoperability problems. Recently, however, it has been indicated that some other approach need be taken to enable operator services. A desired solution has been suggested where a mobile station has in a phone book entry certain information that is descriptive of the MMS capabilities of recipient mobile station(s).

However, prior to this invention there was no effective mechanism to address the problem of how a MMS-capable mobile station is able to obtain and maintain the MMS capabilities of recipient mobile stations for its phone book entry.

Presently the OMA uses UAProf, a W3C-based, rather complex but versatile technology to inform the network of the capabilities of the mobile station. In addition, some service technologies, such as OMA IMPS, have capability negotiation capability. However, end-to-end capability negotiation techniques between peers, such as between MMS Clients, is not commonly found.

It has been suggested that presence technologies, such as OMA IMPS (formerly Wireless Village), or 3GPP/IETF SIP-based presence technologies could be used to obtain, use and maintain the MMS capability information. However, using presence technologies for end-to-end MMS capability information transfer requires the implementation of presence technology in the MMS-capable mobile station, and in the network it requires presence network interworking between operators, in parallel with the MMS network. These requirements, if one were to attempt to implement such presence technologies, could significantly delay the introduction of the capability information transfer from the MMS recipient to MMS sender.

Thus, it can be appreciated that there is an unfulfilled need to provide and use a capability information transfer technology that is confined to the MMS technology itself.

### SUMMARY OF THE PREFERRED EMBODIMENTS

The foregoing and other problems are overcome, and other advantages are realized, in accordance with the teachings of this invention.

Disclosed herein is a method, an apparatus and a computer program to operate a Multimedia Messaging System (MMS), comprising sending a MMS message from a sending mobile station to a recipient mobile station; selectively generating a delivery report that comprises MMS capability information of the recipient mobile station and, if generated, sending the delivery report to the sending mobile station. The delivery report is preferably sent to the sending mobile station at least partially through the use of a SMS message. The delivery report is preferably not generated if denied by the recipient mobile station. In practice, the delivery report is generated by a MMSE of the recipient mobile station based on capability information previously received from the recipient mobile station. The capability information may be used by the sending mobile station to revise, as an example, a phone book entry for the recipient mobile station to include the capability information. The capability information can include, as exemplary, non-limiting examples, at least one of: a) Supported message classes; b) Supported maximum MMS message size; c) Size (in pixels) of the MMS rendering area; d) Supported MMS presentation; and e) Supported additional codecs.

A further aspect of this invention relates to a mobile station having a transmitter and a receiver and a data processor coupled to a memory that operates under control of a stored program to, when operating as a recipient mobile station, and in response to receiving a Multimedia Messaging System (MMS) message from a message source, determining whether to selectively generate a delivery report that comprises MMS capability information of the recipient mobile station for delivery to the message source.

### BRIEF DESCRIPTION OF THE DRAWINGS

The foregoing and other aspects of these teachings are made more evident in the following Detailed Description ofthe Preferred Embodiments, when read in conjunction with the attached Drawing Figures, wherein:

FIG. 1 shows a block diagram of the MMS reference architecture;

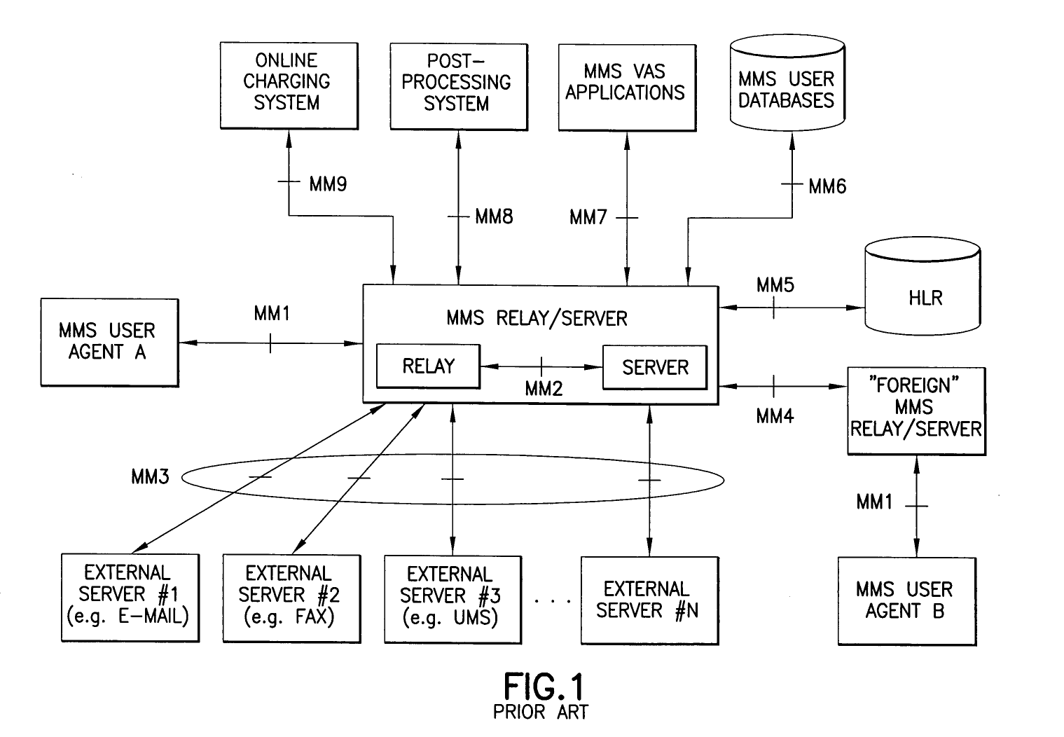

FIG. 2 shows the protocol framework to provide MMS;

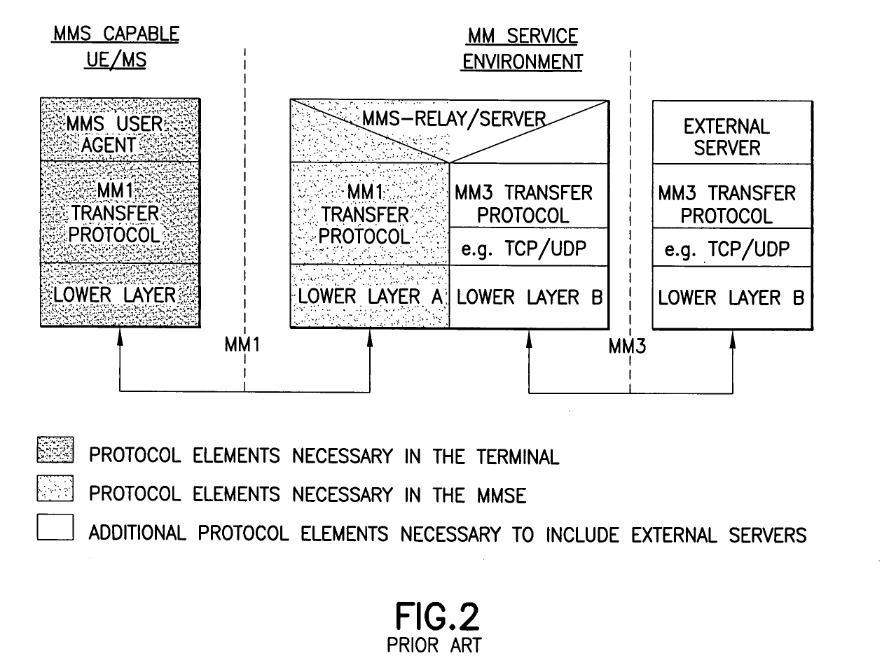

FIG. 3 shows the interworking of different MMSEs;

FIG. 4 shows a logic flow diagram in accordance with the operation of a method, an apparatus and a computer program in accordance with this invention; and

FIG. 5 shows an example of a mobile station suitable for practicing this invention.

### DETAILED DESCRIPTION OF THE PREFERRED EMBODIMENTS

A delivery report in MMS works similarly to a delivery report with SMS: that is, when a MMS message is sent to network, the network sends, if requested, a delivery report to the sender when the message has been delivered to the recipient. This invention enhances this capability, over and above existing MMS (as well as SMS), by providing the recipient of the MMS message a capability to deny sending the delivery report, and to revise the MMS delivery report mechanism to carry MMS capability information from the MMS recipient to the MMS sender.

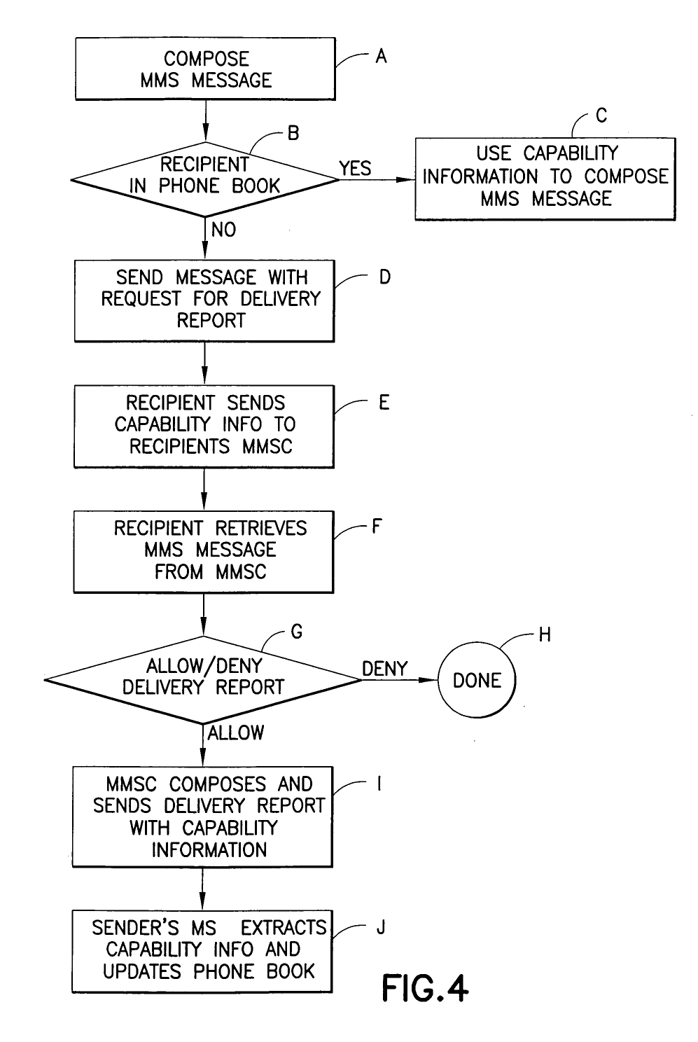

In accordance with this invention, the currently defined MMS sending and retrieval process is modified as follows (reference is also made to FIG. 4):

When the multimedia message is composed (Step A), the recipient mobile station phone book entry is consulted as to whether it contains the capability information (Step B). If available, the information is used to limit the possible content in the multimedia message (Step C). If it is not available, some other technique, such as the creation mode rules of the message classes, are used instead.

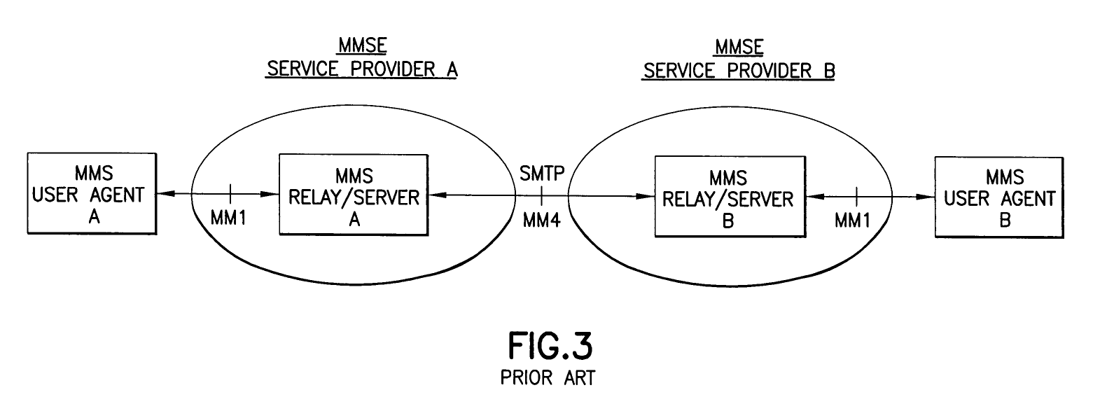

At Step D, when the sending multimedia message the sender requests a delivery report, and the message is sent to sender's home MMSC. The MMSC forwards the message to recipient's home MMSC, possibly through an inter-operator interconnection (see FIG. 3).

The recipient's home MMSC sends a notification to the recipient's mobile station. While connecting to the network to retrieve the message, the recipient mobile station sends its MMS capability information to the network for content adaptation and/or message rejection (Step E).

The recipient mobile station retrieves the multimedia message from MMSC (Step F). When retrieval is finished, the recipient mobile station acknowledges the reception. In this acknowledge message, the recipient mobile station indicates whether it wants to allow or deny the delivery report (Step G). If denied, the message transaction is completed (Step H).

After the acknowledge message is received, the MMSC composes the delivery report if it was allowed and adds the capability information to the delivery report. The delivery report is sent back along the route through which the multimedia message was received (Step I).

At Step J the sender's mobile station receives the delivery report and may display the report to the user. If the report contains the capability information of the recipient mobile station, the phone book entry for the recipient mobile station is updated.

The delivery report is (de-facto) delivered over SMS from sender's MMSC to the sender's mobile station. Thus, the capability information is preferably limited to key elements, which can include (as non-limiting examples):
a) Supported message classes;
b) Supported maximum MMS message size;
c) Size (in pixels) of the MMS rendering area; and
d) Supported MMS presentation (e.g., NMS SMIL, 3GPP PSS5 SMIL, . . . ).

Supported additional codecs may also be indicated.

One advantage gained by the use of this invention is that it employs simple, already available and well characterized elements of the MMS message flow. The introduction of this invention is also simplified, since it does not require that the recipient MMS capable mobile station support the invention (or that the sender's MMSC support the invention). If the recipient's MMSC does not support the invention, then the capability information is simply not available, and a conventional technique maybe used. Also, the privacy of the capability information is maintained, since the recipient mobile station may deny the request to send the delivery report.

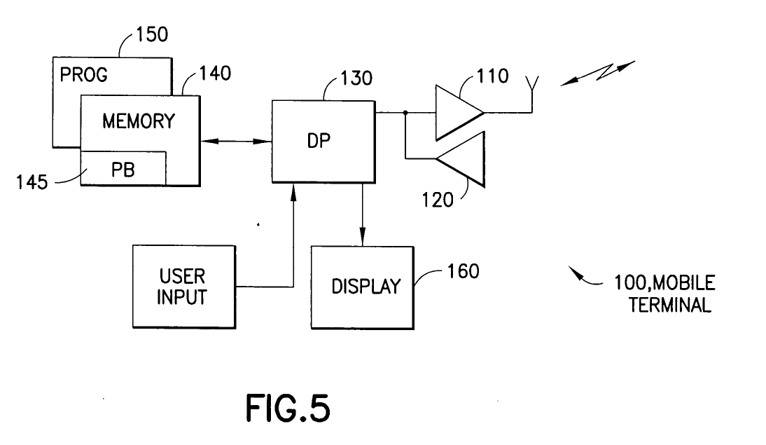

FIG. 5 shows a mobile station or terminal 100 that is suitable for sending and receiving information in accordance with this invention. The mobile terminal 100 includes a wireless radio frequency transmitter 110 and a wireless radio frequency receiver 120, as well as a suitably programmed data processor (DP) 130 coupled to a memory 140. The memory 140 can be any suitable memory, including volatile semiconductor memory and non-volatile semiconductor-based or magnetic media memory, and may be removable. The data processor 130 operates under control of a stored program (Prog) 150 to operate in accordance with the logic flow diagram of FIG. 4 to at least one of compose and transmit MMS messages, receive SMS messages as needed, receive MMS messages and to selectively cause the generation and transmission of the delivery report, as discussed above. A display 160 can be used for displaying a received message, and a user input 170 may be, as non-limiting examples, a keypad, a keyboard or a touchscreen display, whereby the user can interact with the stored program. The memory 140 may store a phone book (PB) data structure 145 that is modifiable as described above. In other embodiments of apparatus for practicing this invention the wireless transmitter 110 and the wireless receiver 120 maybe replaced by other suitable interfaces for connection to a wired or a wireless (e.g., optical or a low power RF) link

In general, the various embodiments of the mobile terminal 100 may include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by a data processor, such as at least in part by the DP 130, or by hardware, or by a combination of software and hardware. Further in this regard it should be noted that the various blocks of the logic flow diagram of FIG. 4 may represent program steps, or interconnected logic circuits, blocks and functions, or a combination of program steps and logic circuits, blocks and functions.

The foregoing description has provided by way of exemplary and non-limiting examples a full and informative description of the best method and apparatus presently contemplated by the inventor for carrying out the invention. However, various modifications and adaptations may become apparent to those skilled in the relevant arts in view of the foregoing description, when read in conjunction with the accompanying drawings and the appended claims. As but some examples, the use of other similar or equivalent message formats may be attempted by those skilled in the art, and the reported capability information may include more than, or less than, the elements listed above. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A method to operate a Multimedia Messaging System (MMS), comprising
sending a MMS message from a sending mobile station to a recipient mobile station; and
selectively generating a delivery report that comprises MMS capability information of the recipient mobile station and, if generated, returning the delivery report to the sending mobile station.

2. A method as in claim 1, where the delivery report is returned to the sending mobile station at least partially through the use of a Short Message Service (SMS) message.

3. A method as in claim 1, where the delivery report is not generated if denied by the recipient mobile station.

4. A method as in claim 1, where the delivery report is generated by a MMSE of the recipient mobile station based on previously received capability information.

5. A method as in claim 1, where the capability information is used by the sending mobile station to revise a phone book entry for the recipient mobile station so as to include the capability information.

6. A method as in claim 1, where the capability information comprises at least one of:
a) supported message classes;
b) supported maximum MMS message size;
c) size (in pixels) of a MMS rendering area;
d) supported MMS presentation; and
e) supported additional codecs.

7. An apparatus, comprising
means for sending a Multimedia Messaging System (MMS) message from a sending mobile station to a recipient mobile station; and
means for selectively generating a delivery report that comprises MMS capability information of the recipient mobile station and, if generated, for returning the delivery report to the sending mobile station.

8. Apparatus as in claim 7, where the delivery report is returned to the sending mobile station at least partially through the use of a Short Message Service (SMS) message.

9. Apparatus as in claim 7, where the delivery report is not generated if denied by the recipient mobile station.

10. Apparatus as in claim 7, where the delivery report is generated by MMSE means of the recipient mobile station based on previously received capability information.

11. Apparatus as in claim 7, where the capability information is used by the sending mobile station to revise a phone book entry for the recipient mobile station so as to include the capability information.

12. Apparatus as in claim 1, where the capability information comprises at least one of:
a) supported message classes;
b) supported maximum MMS message size;
c) size (in pixels) of a MMS rendering area;
d) supported MMS presentation; and
e) supported additional codecs.

13. A computer program embodied on a computer readable medium to operate with a Multimedia Messaging System (MMS), comprising operations of:
sending a MMS message from a sending mobile station to a recipient mobile station; and
selectively generating a delivery report that comprises MMS capability information of the recipient mobile station and, if generated, returning the delivery report to the sending mobile station.

14. A computer program as in claim 13, where the delivery report is returned to the sending mobile station at least partially through the use of a Short Message Service (SMS) message.

15. A computer program as in claim 13, where the delivery report is not generated if denied by the recipient mobile station.

16. A computer program as in claim 13, where the delivery report is generated by a MMSE of the recipient mobile station based on previously received capability information.

17. A computer program as in claim 13, where the capability information is used by the sending mobile station to perform an operation of revising a phone book entry for the recipient mobile station so as to include the capability information.

18. A computer program as in claim 13, where the capability information comprises at least one of:
a) supported message classes;
b) supported maximum MMS message size;
c) size (in pixels) of a MMS rendering area;
d) supported MMS presentation; and
e) supported additional codecs.

19. A mobile station comprising a transmitter and a receiver and a data processor coupled to a memory and operating under control of a stored program to, when operating as a recipient mobile station, in response to receiving a Multimedia Messaging System (MMS) message from a message source, determining whether to selectively generate a delivery report that comprises MMS capability information of the recipient mobile station for delivery to the message source.

20. A mobile station as in claim 19, where the delivery report is sent at least partially through the use of a Short Message Service (SMS) message.

21. A mobile station as in claim 19, where the delivery report is not generated if denied by the recipient mobile station.

22. A mobile station as in claim 19, where the delivery report is generated by a MMSE of the recipient mobile station based on previously received capability information.

23. A mobile station as in claim 19, where when operating as the message source, using the capability information to perform an operation of revising a phone book entry for the recipient mobile station so as to include the capability information.

24. A mobile station as in claim 19, where the capability information comprises at least one of:
a) supported message classes;
b) supported maximum MMS message size;
c) size (in pixels) of a MMS rendering area;
d) supported MMS presentation; and
e) supported additional codecs.

25. A mobile station as in claim 19, where the message source comprises another mobile station.
